(19) United States
(12) Patent Application Publication
(10) Pub. No.: US 2014/0238562 A1
(43) Pub. Date: Aug. 28, 2014

(54) PNEUMATIC TIRE

(71) Applicant: TOYO TIRE & RUBBER CO., LTD., Osaka (JP)

(72) Inventor: Kazutaka Hana, Osaka-shi (JP)

(73) Assignee: TOYO TIRE & RUBBER CO., LTD., Osaka (JP)

(21) Appl. No.: 14/148,177

(22) Filed: Jan. 6, 2014

(30) Foreign Application Priority Data
Feb. 22, 2013 (JP) 2013-033646

(51) Int. Cl. B60C 19/08

(52) U.S. Cl. CPC B60C 19/08
USPC 152/152.1

(57) ABSTRACT

A tire has a tread rubber and a conductive portion. The conductive portion is formed so as to connect the ground surface and a side surface of a side end portion of the tread rubber in a tire meridian circle cross section. The conductive portion having a rubber hardness which is different from the tread rubber, and has a stem portion and a plurality of branch portions. The stem portion heads for an inner side in the tire width direction from the side surface of the side end portion of the tread rubber so as to terminate at an inner portion of the tread rubber. The plurality of branch portions are branched from a plurality of positions of the stem portion so as to head for an outer side in the tire width direction and be exposed to an outer surface of the tire.

### BACKGROUND OF THE INVENTION

1. Field of the Invention

The present invention relates to a pneumatic tire in which a steering stability is made appropriate as well as a conduction performance is secured.

2. Description of the Related Art

In recent years, for the purpose of reducing a rolling resistance of a tire which has strong relationship to a fuel consumption performance, there has been proposed a pneumatic tire in which a rubber member such as a tread rubber is formed by a non-conductive rubber blended with silica at a high rate. However, since an electric resistance is higher in the rubber member in comparison with a conventional product which is formed by a conductive rubber blended with carbon black at a high rate, and inhibits static electricity generated in a vehicle body or the tire from being discharged to a road surface, the rubber member has a problem that a problem such as a radio noise tends to be generated. Consequently, it is necessary to appropriately secure a conductive route for discharging the static electricity.

Consequently, there has been developed a pneumatic tire in which a conductive route is secured by the provision of the conductive rubber blended with the carbon black while forming the tread rubber by the non-conductive rubber. For example, in the pneumatic tire described in JP-A-2009-126291 and JP-A-2007-290485, a conductive portion formed by a conductive rubber is provided in one end portion in a tire width direction of a tread rubber which is formed by a non-conductive rubber. The conductive route for discharging the static electricity is secured by arranging the conductive portion in a side surface of the end portion of the tread rubber or from a bottom surface of the end portion to a ground surface.

### PRIOR ART DOCUMENTS

Patent Document 1: Japanese Unexamined Patent Publication No. JA-A-2009-126291
Patent Document 1: Japanese Unexamined Patent Publication No. JA-A-2007-290485

### SUMMARY OF THE INVENTION

However, in both the tires of JP-A-2009-126291 and JP-A-2007-290485, since the conductive portion is constructed by one line in a tire meridian circle cross section, and is exposed only at one position of a tire outer surface, there is a risk that the conductive portion comes up from the road surface on the basis of a behavior or the tire, so that it can not be said that the conduction performance can be always achieved.

Further, a steering stability on a dry road surface and a steering stability on a wet road surface are required as occasion demands. Generally, the higher a modulus (a rubber hardness) of the tread rubber (that is, the ground surface) is, the higher a pressure per unit area is at a degree that the grounded area is reduced. Therefore, the steering stability on the dry road surface is improved. On the other hand, the lower the modulus rubber hardness of the ground surface is, the more the steering stability on the wet road surface is improved at a degree that the grounded area is increased.

As a result, the steering stability can be improved on the dry road surface or the wet road surface according to the hardness of the tread rubber, however, since these performances are in a conflicting relationship (which may be called as a fighting relationship), it is hard to obtain a desired steering stability only by setting the hardness of the tread rubber. In other words, it is hard to improve the steering stability of any one of the dry road surface and the wet road surface in a state of maintaining the steering stability of the other, and exponentially improve the steering stability of any one of the dry road surface and the wet road surface while somewhat sacrificing the steering stability of the other.

The present invention is made by paying attention to the problem mentioned above, and an object of the present invention is to provide a pneumatic tire which improves a degree of freedom for setting a steering stability on a dry road surface and a steering stability on a wet road surface as well as appropriately achieving a conduction performance.

The present invention employs the following means for achieving the object.

In other words, according to the present invention, there is provided a pneumatic tire including a tread rubber which is arranged in a tread portion of the tire, forms a ground surface and is made of a conductive rubber; and a conductive portion which is provided at least in one side of a tire width direction of the tread rubber, and is formed so as to connect the ground surface and a side surface or a bottom surface of a side end portion of the tread rubber in a tire meridian circle cross section through an inner portion of the tread rubber, wherein the conductive portion is formed by a conductive rubber having a rubber hardness which is different from the tread rubber, and has a stem portion which heads for an inner side in the tire width direction from the side surface or the bottom surface of the side end portion of the tread rubber so as to terminate at an inner portion of the tread rubber, and a plurality of branch portions which are branched from a plurality of positions of the stem portion so as to head for an outer side in the tire width direction and be exposed to an outer surface of the tire, and wherein the plurality of branch portions construct a tread rigidity changing portion which changes a rigidity of the tread portion in comparison with a case that the plurality of branch portions are not provided.

According to the structure, since the branch portions are exposed to a plurality of positions on the outer surface of the tire, probability at which the conductive portion is grounded on the road surface is enhanced in comparison with the structure in which the conductive portion is exposed at one position on the outer surface of the tire, and it is possible to accurately achieve the conduction performance. At the same time, since a plurality of branch portions having the different rubber hardness from the tread rubber construct the tread rigidity changing portion which changes the rigidity of the tread portion in comparison with the case that the branch portions are not provided, it is possible to set the tread portion to a desired rigidity, and it is possible to improve a degree of freedom for designing the steering stability on the dry road surface and the steering stability on the wet road surface which has been hard to be obtained only by setting the hardness of the tread rubber.

In order to improve the steering stability, it is preferable that the plurality of branch portions are arranged so that an angle between a line connecting a branch position and an exposure position and a horizontal line heading for the outer side in the tire width direction is equal to or more than 0 degree and equal to or less than 70 degrees, in the tire meridian circle cross section, and the branch portion constructs a deforming direction guide portion guiding a direction in which the tread portion deforms due to a pressure from a road surface to the outer side in the tire width direction.

The tread rigidity change portion is constructed as long as the angle is equal to or more than 0 degree and less than 90 degrees, that is, the branch portion is not upright but heads for the outer side in the tire width direction. Accordingly, the present invention can improve the degree of freedom for setting the steering stability. Further, the deforming direction guide portion is constructed as long as the angle is equal to or more than 0 degree and equal to or less than 70 degree. Accordingly, it is further possible to significantly improve the degree of freedom for setting the steering stability.

In order to pursue the improvement of the steering stability, it is preferable to set the angle to be equal to or more than 0 degree and equal to or less than 50 degrees. In order to further pursue the improvement of the steering stability, it is effective to set the angle to be equal to or more than 0 degree and equal to or less than 35 degrees.

In order to more further improve the steering stability, it is preferable that the branch portions are curved so as to protrude toward the outer side in the tire radial direction than a line connecting the branch position and the exposure position, in the tire meridian circle cross section.

In order to suppress to the disconnection of the conductive portion, it is preferable that at least two main grooves extending in a tire peripheral direction are formed in the tread rubber, and wherein at least one branch portion and the stem portion are arranged at a position which laps over the main groove existing in the outermost side in the tire width direction as seen from the tire radial direction.

### BRIEF DESCRIPTION OF THE DRAWINGS

FIG. 1 is a tire meridian circle cross sectional view showing an example of a pneumatic tire according to an embodiment of the present invention

FIG. 2 is an enlarged cross sectional view schematically showing a periphery of a side end portion of a tread rubber;

FIG. 3A is a cross sectional view schematically showing a shape of a branch portion according to the present embodiment;

FIG. 3B is a cross sectional view schematically showing a branch portion according to the other embodiment than the above of the present invention;

FIG. 3C a cross sectional view schematically showing a branch portion according to the other embodiment than the above of the present invention;

FIG. 4 is an enlarged cross sectional view schematically showing a periphery of a side end portion of a tread rubber;

FIG. 5 is a tire meridian circle cross sectional view showing an example of a tire according to the other embodiment than the above of the present invention;

FIG. 6A is a view schematically showing a winding route of a ribbon winding construction method according to the present embodiment;

FIG. 6B is a view schematically showing a winding route according to the other embodiment than the above of the ribbon winding construction method;

FIG. 6C is a view schematically showing a winding route according to the other embodiment than the above of the ribbon winding construction method;

FIG. 6D is a view schematically showing a winding route according to the other embodiment than the above of the ribbon winding construction method; and

FIG. 6E is a view schematically showing a winding route according to the other embodiment than the above of the ribbon winding construction method.

### DETAILED DESCRIPTION OF THE PREFERRED EMBODIMENTS

A description will be given below of a pneumatic tire according to an embodiment of the present invention with reference to the accompanying drawings.

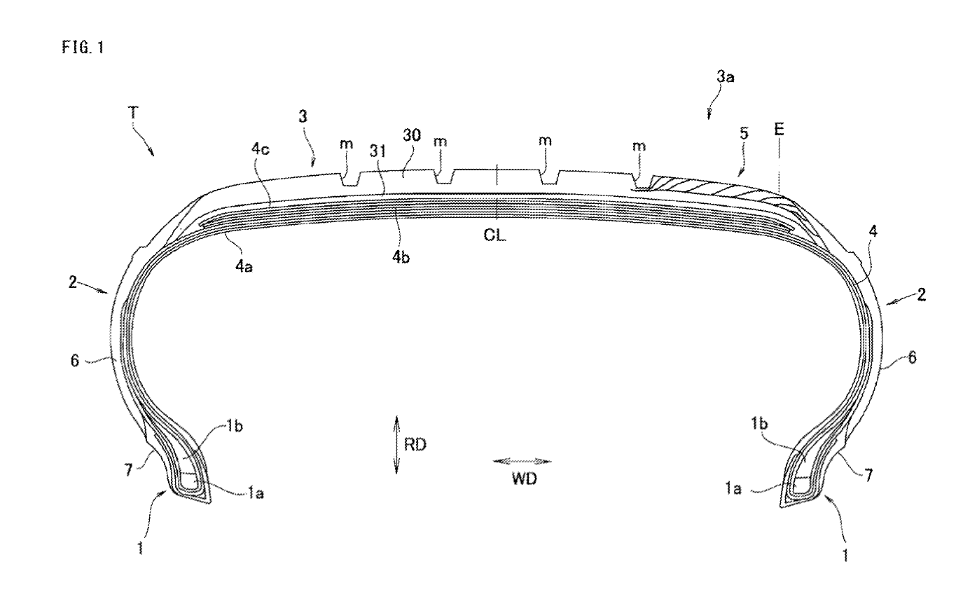

As shown in FIG. 1, a pneumatic tire T is provided with a pair of bead portions 1, side wall portions 2 which extend to outer sides in a tire radial direction RD from the respective bead portions 1, and a tread portion 3 which is connected to outside ends in the tire radial direction RD from both the side wall portions 2. An annular bead core 1a and a bead filler 1b are arranged in the bead portion 1, the annular bead core 1a covering a convergence body such as a steel wire by a rubber, and the bead filler 1b being made of a hard rubber.

Further, the tire T is provided with a toroidal carcass layer 4 which runs into the bead portions 1 from the tread portion 3 via the side wall portions 2. The carcass layer 4 is provided between a pair of bead portions 1, is constructed by at least one carcass ply, and is locked in a state in which its end portions are rolled up via the bead cores 1a. The carcass ply is formed by coating with a topping rubber a cord which extends approximately vertically to a tire equator CL. An inner liner rubber 4a for retaining a pneumatic pressure is arranged in an inner side of the carcass layer 4.

Further, side wall rubbers 6 are provided in outer sides of the carcass layer 4 in the side wall portions 2. Further, rim strip rubbers 7 coming into contact with a rim (not shown) at a time of being installed to the rim are provided in the outer sides of the carcass layer 4 in the bead portions 1. In the present embodiment, a topping rubber of the carcass layer 4, the rim strip rubbers 7 and the side wall rubbers 6 are formed by a conductive rubber.

An outer side of the carcass layer 4 in the tread portion 3 is provided with a belt 4b for reinforcing the carcass layer 4, a bet reinforcing member 4c, a base rubber 31 and a tread rubber 30 in this order from an inner side toward an outer side. The belt 4b is constructed by a plurality of belt plies. The belt reinforcing member 4b is constructed by coating a cord extending in a tire peripheral direction with a topping rubber. The belt reinforcing member 4b may be omitted as occasion demands.

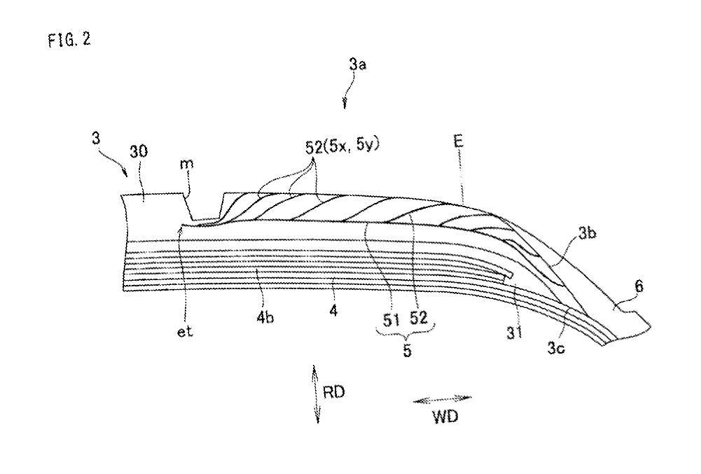

As shown in FIG. 1, the tread rubber 30 is called as a cap rubber, is arranged in the tread portion 3 of the tire, and is formed by a non-conductive rubber which forms a ground surface. The base rubber 31 is formed by a non-conductive rubber and is provided in an inner side in a tire radial direction RD of the tread rubber 30. FIG. 2 is an enlarged view of a periphery of a side end portion of the tread rubber 30. As shown in FIG. 2, one side in a tire width direction WD of the tread rubber 30 is provided with a conductive portion 5 which is formed so as to connect the ground surface and the side surface 3b of the side end portion 3a of the tread rubber 30 through an inner portion of the tread rubber 30 in a tire meridian circle cross section. In the present embodiment, the base rubber 31 is formed by the non-conductive rubber, however, may be formed by a conductive rubber.

In the above, the ground surface is a surface which is grounded onto a road surface when the tire is vertically put on a flat road surface in a state in which the tire is assembled in a normal rim, and a normal internal pressure is filled, and a normal load is applied to the tire, and an outermost position in the tire width direction WD comes to a ground end E. The normal load and the normal internal pressure indicate a maximum load (a design normal load in the case of a tire for a passenger car) which is defined in JISD4202 (specification of an automotive tire) and a corresponding pneumatic pressure, and the normal rim indicates a standard rim which is defined in JISD4202 in principle.

The present embodiment employs a side-on tread structure achieved by mounting the side wall rubbers 6 onto both side end portions of the tread rubber 30, however, can employ a tread-on side structure achieved by mounting both side end portions of the tread rubber onto outer ends in the tire radial direction RD of the side wall rubbers, without being limited to the side-on tread structure.

Here, the conductive rubber is exemplified by a rubber in which a volume resistivity indicates a value less than 10⁸ Ω·cm, and is produced, for example, by blending a carbon black serving as a reinforcing agent in a raw material rubber at a high rate. The conductive rubber can be obtained by blending a known conductivity applying agent, for example, a carbon-based conductivity applying agent such as a carbon fiber or a graphite, and a metal-based conductivity applying agent such as a metal powder, a metal oxide, a metal flake or a metal fiber, in addition to the carbon black.

Further, the non-conductive rubber is exemplified by a rubber in which a volume resistivity indicates a value equal to or more than 10⁸ Ω·cm, and is exemplified by a material obtained by blending a silica serving as a reinforcing agent in the raw material rubber at a high rate. The silica is blended, for example, at 30 to 100 weight part in relation to 100 weight part of the raw material rubber component. The silica preferably employs a wet silica, however, can use any silica which is generally used as the reinforcing agent, without limitation. The non-conductive rubber may be produced by blending a burned clay, a hard clay, or a calcium carbonate, in addition to the silica such as a precipitated silica or a silicic anhydride.

As the raw material rubber mentioned above, a natural rubber, a styrene butadiene rubber (SBR), a butadiene rubber (BR), an isoprene rubber (IR) and an isobutylene-isoprene rubber (IIR) can be listed up, and they are used respectively by itself or by mixing two or more kinds. A vulcanizing agent, a vulcanization accelerator, a plasticizer or an antioxidant is appropriately blended in the raw material rubber.

In the light of enhancing a durability and improving a conduction performance, the conductive rubber forming the conductive portion 5 desirably has a composition that a nitrogen adsorption specific surface area: N₂SA (m²/g)×composition amount (mass %) of carbon black is equal to or more than 1900, preferably equal to or more than 2000, and a dibutyl phthalate oil absorption: DBP (ml/100 g)×composition amount (mass %) of carbon black is equal to or more than 1500, preferably equal to or more than 1700. N₂SA can be determined in conformity to ASTM D3037-89, and DBP can be determined in conformity to D2414-90.

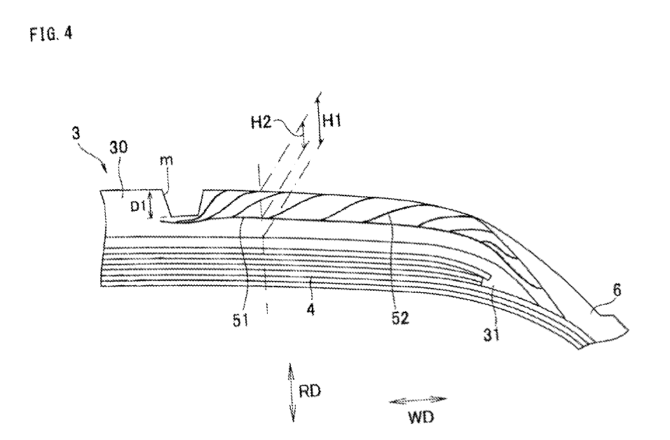

As shown in FIG. 2, the conductive portion 5 is formed by a conductive rubber having a different rubber hardness from the tread rubber 30, and has a stem portion 51 and a plurality of branch portions 52. The stem portion 51 heads for an inner side in the tire width direction WD from the side surface 3b of the side end portion 3a of the tread rubber 30 and terminates at an inner portion of the tread rubber 30. A plurality of branch portions 52 are branched from a plurality of positions of the stem portion 51 so as to head for an outer side in the tire width direction WD and be exposed to an outer surface of the tire. As shown in FIG. 4, on the assumption that a thickness of the tread rubber 30 is H1, a leading end side (the inner side in the tire width direction) of the stem portion 51 is arranged at a position where a distance from the ground surface is H2. The stem portion 51 is preferably arranged at a position having a relationship H2≦H1×0.9. This is because the stem portion 51 is passed through the inner portion of the tread rubber 30 so as to prevent the stem portion 51 from coming into contact with the base rubber 31. Further, it is preferable to achieve a relationship H2≦H1×0.75. This is for the purpose of avoiding reduction of a low fuel consumption performance in the tread rubber 30 as much as possible. Further, on the assumption that a depth of the main groove m is D1 as shown in FIG. 4, H2≧D1 is defined as an upper limit position of the stem portion 51.

A rubber hardness difference between the tread rubber 30 and the conductive portion 5 is preferably equal to or more than 1 degree, and is more effectively equal to or more than 3 degrees. The rubber hardness here means a hardness which is measured in conformity to a durometer hardness test (type A) of JISK6253. The higher rubber hardness indicates that the rubber is harder, and the lower rubber hardness indicates that the rubber is softer.

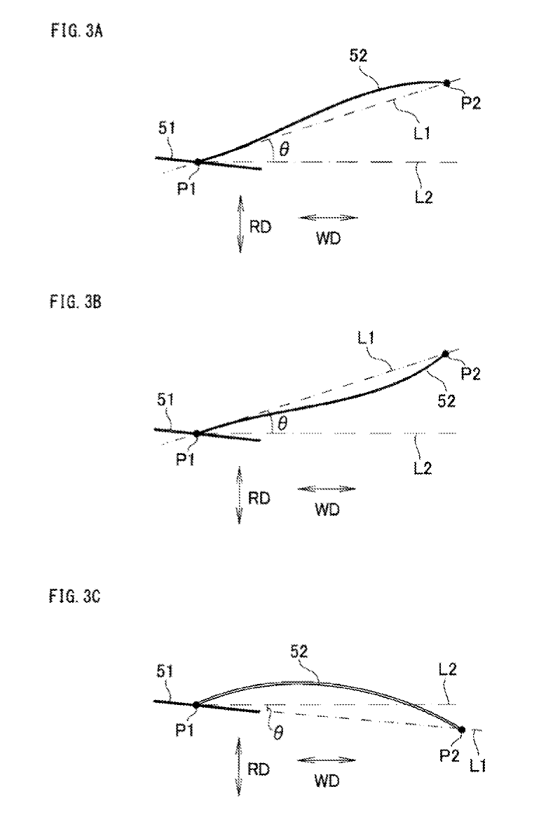

A plurality of branch portions 52 mentioned above are arranged so that an angle θ between a line L1 connecting a branch position P1 and an exposure position P2, and a horizontal line L2 heading for the outer side in the tire width direction WD is equal to or more than 0 degree and less than 90 degrees, in the tire meridian circle cross section, as shown in FIG. 3A. As mentioned above, since the branch portions 52 are inclined to the outer side in the tire width direction than the vertical direction, and the branch portions 52 are formed by the different rubber hardness than the tread rubber 30, a rigidity of the tread portion 3 is changed. In other words, as shown in FIG. 2, a plurality of branch portions 52 construct a tread rigidity changing portion 5x which changes the rigidity of the tread portion 3 in comparison with the case that a plurality of branch portions 52 are not provided.

Further, in the case that the angle θ is close to 90 degrees, that is, in the case that the branch portions 52 are close to the upright state, the tread portion 3 deforms toward the outer side in the tire width direction or the inner side in the tire width direction due to the pressure from the road surface, however, there can be thought that a dispersion is generated in a deforming direction. Consequently, in the present embodiment, a plurality of branch portions 52 are arranged so that the angle θ mentioned above is equal to or more than 0 degree and equal to or less than 70 degrees. In the case that the branch portions 52 are arranged under the attitude mentioned above, the direction in which the tread portion 3 (particularly the ground surface) is deformed by the pressure from the road surface is guided to the outer side in the tire width direction. In other words, the branch portions 52 construct a deforming direction guide portion 5y guiding the direction in which the tread portion 3 is deformed by the pressure from the road surface, to the outer side in the tire width direction WD. The angle θ mentioned above is preferably equal to or more than 0 degree and equal to or less than 70 degrees, however, in order to further achieve the effect, the angle is preferably equal to or more than 0 degree and equal to or less than 50 degree, and in order to further enhance the effect, the angle is preferably equal to or more than 0 degree and equal to or less than 35 degrees.

In the present embodiment, the branch portion 52 has a curved shape which rises up toward the outer side in the tire width direction WD and the outer side in the tire radial direction RD from the branch position P1, as shown in FIG. 3A. In other words, the branch portion 52 is curved so as to protrude toward the outer side in the tire radial direction RD than the line L1 connecting the branch position P1 and the exposure position P2, in the tire meridian circle cross section. Since the leading end of the branch portion 52 heads for the outer side in the tire width direction WD as long as this shape, the force heading for the inner side from the outer side in the tire width direction can be appropriately received. Of course, in the case that the angle θ mentioned above is small, the branch portion 52 may be curved so as to protrude toward the inner side in the tire radial direction RD than the line L1 connecting the branch position P1 and the exposure position P2, in the tire meridian circle cross section, as shown in FIG. 3B. Further, as shown in FIG. 3C, there can be a case that the exposure position P2 comes to the inner side in the tire radial direction than the horizontal line L2.

Turning back to FIG. 1, at least two main grooves m extending in the tire peripheral direction are formed in the tread rubber 30. In the present embodiment, four main grooves are formed, however, three main grooves may be formed. As shown in FIG. 2, at least one branch portion 52 and the stem portion 51 are arranged at a position at which they lap over the main groove m in the outermost side in the tire width direction WD as seen from the tire radial direction RD. This means that the branch portions 52 and the stem portion 51 are positioned below the main groove m as shown in FIG. 2.

An area where the conductive portion 5 is arranged is preferably from an end of the tread rubber 30 to the main groove m existing in the outermost side in the tire width direction, however, may be at least to the vicinity of the main groove m. For example, as shown in FIG. 2, it is desirable that a terminal end et of the stem portion 51 is within 15 mm from the main groove m toward the outer side in the tire width direction, is preferably within 5 mm. Further, the branch portions 52 may be provided in the inner side than the main groove m. Further, the terminal end et of the stem portion 51 can be optionally set as long as the terminal end et is in the inner side in the tire width direction than the main groove m.

The tread rubber 30 and the conductive portion 5 are formed according to a so-called ribbon winding construction method. The ribbon winding construction method is a construction method for forming a rubber member having a desired cross sectional shape by spirally winding an unvulcanized ribbon rubber along a tire peripheral direction. In order to simultaneously form the tread rubber 30 and the conductive portion 5, a ribbon rubber obtained by coating one face of a non-conductive rubber with a conductive rubber is used. In order to form only the tread rubber 30 without forming the conductive portion 5, a ribbon rubber of the non-conductive rubber is used. The formation can be achieved only by changing the used ribbon rubber.

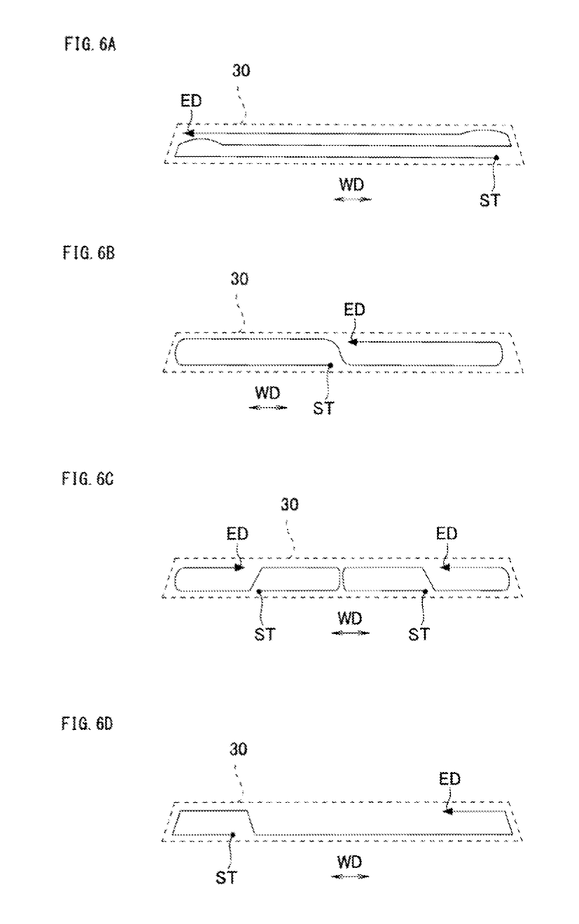

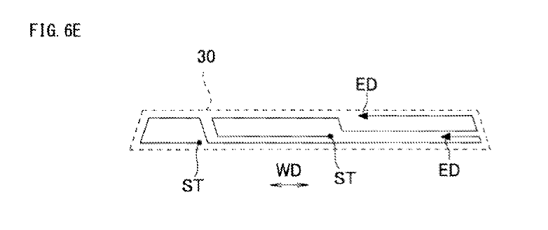

Since the tread portion 3 can be formed by the ribbon winding construction method as mentioned above, each of the stem portion 51 and the branch portions 52 is formed as a band shape which extends along the tire peripheral direction. The smaller the angle θ of the branch portion 52 is, the larger an area of the band shape is, so that the effect of improving the driving performance and the braking performance is enlarged. A route of the ribbon winding according to the present embodiment is as shown in FIG. 6A, however, routes shown in FIGS. 6B to 6E can be additionally employed. FIG. 6 shows the tread rubber 30 in the unvulcanized state, a start point ST for the ribbon winding, and an end point ED for the ribbon winding.

As mentioned above, the pneumatic tire according to the present embodiment has a pair of bead portions 1, the side wall portions 2 which extend to the outer sides in the tire radial direction RD from the respective bead portions 1, the tread portion 3 which is connected to the outside ends in the tire radial direction RD of the respective side wall portions 2, the toroidal carcass layer 4 which is provided between a pair of bead portions 1, and the side wall rubbers 6 which are provided in the outer sides of the carcass layer 4 in the side wall portions 2. the tire including a tread rubber (30) which is arranged in a tread portion (3) of the tire, forms a ground surface and is made of a conductive rubber; and a conductive portion (5) which is provided at least in one side of a tire width direction (WD) of the tread rubber (30), and is formed so as to connect the ground surface and a side surface (3b) of a side end portion (3a) of the tread rubber (30) in a tire meridian circle cross section through an inner portion of the tread rubber (30). The conductive portion (5) is formed by a conductive rubber having a rubber hardness which is different from the tread rubber (30), and has a stem portion (51) which heads for an inner side in the tire width direction (WD) from the side surface (3b) of the side end portion (3a) of the tread rubber (30) so as to terminate at an inner portion of the tread rubber (30), and a plurality of branch portions (52) which are branched from a plurality of positions of the stem portion (51) so as to head for an outer side in the tire width direction (WD) and be exposed to an outer surface of the tire. The plurality of branch portions (52) construct a tread rigidity changing portion (5x) which changes a rigidity of the tread portion (3) in comparison with a case that the plurality of branch portions (52) are not provided.

According to the structure, since the branch portions 52 are exposed to a plurality of positions on the outer surface of the tire, probability at which the conductive portion 5 is grounded on the road surface is enhanced in comparison with the structure in which the conductive portion 5 is exposed at one position on the outer surface of the tire, and it is possible to accurately achieve the conduction performance. At the same time, since a plurality of branch portions 52 having the different rubber hardness from the tread rubber 30 construct the tread rigidity changing portion 5x which changes the rigidity of the tread portion 3 in comparison with the case that the branch portions 52 are not provided, it is possible to set the tread portion 3 to a desired rigidity, and it is possible to improve a degree of freedom for designing the steering stability on the dry road surface and the steering stability on the wet road surface which has been hard to be obtained only by setting the hardness of the tread rubber 30.

In the case that the branch portions 52 rise up in the tire radial direction RD (the vertical direction), the deforming direction of the tread portion 3 is dispersed, the tread portion 3 does not form a uniform deformation and the rigidity of the tread portion 3 is uneven along the tire peripheral direction, when the branch portions 52 are exposed to the compression due to the pressure in the vertical direction from the road surface. As a result, the tread portion can not appropriately receive the force along the tire width direction WD, and the improvement of the steering stability is not sufficient.

Consequently, according to the present invention, the plurality of branch portions (52) are arranged so that an angle (θ) between a line (L1) connecting a branch position (P1) and an exposure position (P2) and a horizontal line (L2) heading for the outer side in the tire width direction (WD) is equal to or more than 0 degree and equal to or less than 70 degrees, in the tire meridian circle cross section, and the branch portion (52) constructs a deforming direction guide portion (5y) guiding a direction in which the tread portion (3) deforms due to a pressure from a road surface to the outer side in the tire width direction (WD). According to the present invention, it is possible to receive the pressure in the vertical direction from the road surface while uniformly deforming to the outer side in the tire width direction, the rigidity is uniform along the tire peripheral direction, it is possible to appropriately receive the force along the tire width direction, and it is possible to significantly improve the steering stability. Further, the length of the branch portions 52 becomes longer in the case that the branch portions 52 lie down in comparison with the case that the branch portions 52 rise up in the vertical direction. As a result, it is possible to improve any of the driving performance and the braking performance according to whether the branch portions 52 are higher or lower in their rubber hardness than the tread rubber.

Further, according to the present embodiment, the branch portions (52) are curved so as to protrude toward the outer side in the tire radial direction (RD) than a line (L1) connecting the branch position (P1) and the exposure position (P2), in the tire meridian circle cross section. According to the structure, the branch portions 52 can appropriately receive the force heading for the inner side from the outer side in the tire width direction, and it is possible to more further improve the steering stability. Same applies to the driving performance and the braking performance.

Further, according to the present embodiment, at least two main grooves (m) extending in a tire peripheral direction are formed in the tread rubber (30), and wherein at least one branch portion (52) and the stem portion (51) are arranged at a position which laps over the main groove (m) existing in the outermost side in the tire width direction (WD) as seen from the tire radial direction. According to the structure, since the branch portions 52 and the stem portion 51 are arranged at the position which laps over the main groove m as seen from the tire radial direction RD, in the case that the main groove m is formed by the metal mold, the conductive portion 5 becomes thicker in comparison with the case that only the stem portion 51 is arranged. Therefore, the conductive portion 5 is not disconnected when the main groove is formed by the metal mold, and it is possible to secure the conductive route from the edge of the groove.

### Other Embodiments

(1) In the present embodiment, the topping rubber of the carcass layer 4 and the rim strip rubber 7 are formed by the conductive rubber, and the side wall rubber 6 is formed by the non-conductive rubber, however, the topping rubber of the carcass, the rim strip rubber and the side wall rubber may be formed by the non-conductive rubber or may be formed by the conductive rubber, as long as the conductive route is constructed between the ground surface of the tread portion and the rim contact position in the rim strip rubber. The combination thereof can be appropriately changed.

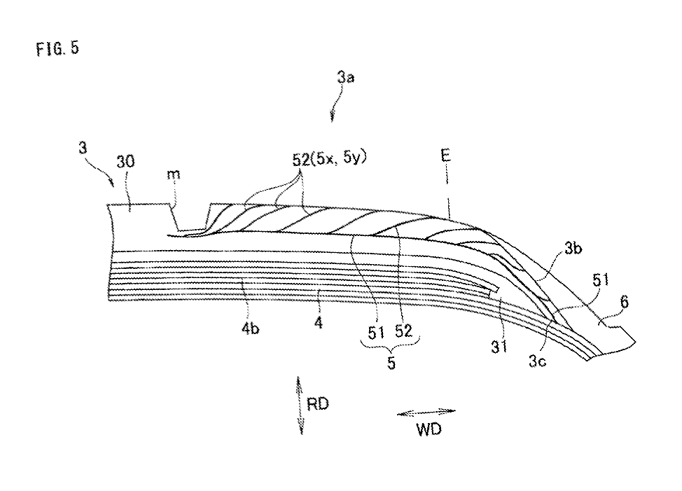

(2) Further, the stem portion 51 extends from the side surface 3b of the side end portion 3a of the tread rubber 30, however, may extend from the bottom surface 3c as shown in FIG. 5. Further, in the present embodiment, a cap portion 50 is formed by the non-conductive rubber, however, may be formed by the conductive rubber.

(3) Furthermore, the conductive portion 5 is provided in only one side in the tire width direction WD of the tread rubber 30 in the present embodiment, however, may be provided in both sides in the tire width direction WD.

### EXAMPLES

In order to specifically show the structure and the effect of the present invention, the following evaluation were made about the following examples.

(1) Rubber Hardness

A rubber composition was vulcanized for 30 minutes at 150° C., and a rubber hardness of the vulcanized rubber at 23° C. was measured in conformity to JISK6253.

(2) Steering Stability

A steering stability was compared by a feeling evaluation according to a dry road surface traveling and a wet road surface traveling using an actual car. In the following Table 1, examples were evaluated by an index number while setting a case of a comparative example 1 to 100. In the following Table 2, the examples were evaluated by an index number while setting a case of a comparative example 2 to 100. The greater the index number is, the higher and the more preferable the steering stability is.

(2) Braking Performance

A braking distance when a traveling speed of an actual car (a domestic car) was slowed down from 100 km/h to 0 km/h was measured, and was evaluated by an index number. In the following Table 1, the examples were evaluated by the index number while setting a case of the comparative example 1 to 100. In the following Table 2, the examples were evaluated by the index number while setting a case of the comparative example 2 to 100. The greater the index number is, the higher and the more preferable the braking performance is.

(3) Driving Performance

DRYμ was measured by a bus type traction measuring instrument, and was evaluated by an index number. In the following Table 1, the examples were evaluated by the index number while setting a case of the comparative example 1 to 100. In the following Table 2, the examples were evaluated by the index number while setting a case of the comparative example 2 to 100. The greater the index number is, the higher and the more preferable the driving performance is.

### Example 1

As shown in FIG. 2, the conductive portion constructed by the stem portion 51 and a plurality of branch portions 52 was formed in the tread rubber 30 of the non-conductive rubber. The angle θ of the branch portions 52 in relation to the horizontal direction was set to 70 degrees. The rubber hardness of the tread rubber 30 (the cap rubber) was set to 70 degrees, the rubber hardness of the conductive portion was set to 80 degrees, and the conductive portion 5 was made harder than the tread rubber 30.

### Example 2

The angle θ of the branch portions 52 was set to 50 degrees, in relation to the tire of the example 1. The other elements were set to the same as the tire of the example 1.

### Example 3

The angle θ of the branch portions 52 was set to 35 degrees, in relation to the tire of the example 1. The other elements were set to the same as the tire of the example 1.

### Example 4

The angle θ of the branch portions 52 was set to 71 degrees, in relation to the tire of the example 1. The other elements were set to the same as the tire of the example 1.

### Example 5

The rubber hardness of the conductive portion was set to 71 degrees, in relation to the tire of the example 3. The other elements were set to the same as the tire of the example 1.

### Example 6

The rubber hardness of the tread rubber 30 (the cap rubber) was set to 70 degrees, the rubber hardness of the conductive portion was set to 60 degrees, and the conductive portion 5 was made softer than the tread rubber 30.

### Example 7

The angle θ of the branch portions 52 was set to 50 degrees, in relation to the tire of the example 6. The other elements were set to the same as the tire of the example 6.

### Example 8

The angle θ of the branch portions 52 was set to 35 degrees, in relation to the tire of the example 6. The other elements were set to the same as the tire of the example 6.

### Example 9

The angle θ of the branch portions 52 was set to 71 degrees, in relation to the tire of the example 6. The other elements were set to the same as the tire of the example 6.

### Example 10

The rubber hardness of the conductive portion was set to 69 degrees, in relation to the tire of the example 6. The other elements were set to the same as the tire of the example 6.

### Comparative Example 1

The angle θ of the branch portions 52 was set to 90 degrees, in relation to the tire of the example 1. The other elements were set to the same as the tire of the example 1.

### Comparative Example 2

The angle θ of the branch portions 52 was set to 90 degrees, in relation to the tire of the example 6. The other elements were set to the same as the tire of the example 6.

TABLE 1

| | Com- | | | | | |
|---|---|---|---|---|---|---|
| | parative | | | | | |
| | Exam- | Exam- | Exam- | Exam- | Exam- | Exam- |
| | ple 1 | ple 1 | ple 2 | ple 3 | ple 4 | ple 5 |
| rubber hardness | 70 | 70 | 70 | 70 | 70 | 70 |
| of cap portion | | | | | | |
| (tread rubber) | | | | | | |
| rubber hardness | 80 | 80 | 80 | 80 | 80 | 71 |
| of conductive | | | | | | |
| portion | | | | | | |
| angle θ | 90 | 70 | 50 | 35 | 71 | 35 |
| [degree] of | | | | | | |
| branch portion | | | | | | |
| dry steering | 100 | 103 | 105 | 105 | 101 | 103 |
| stability | | | | | | |
| wet steering | 100 | 101 | 102 | 103 | 100 | 103 |
| stability | | | | | | |
| driving | 100 | 101 | 102 | 102 | 101 | 101 |
| performance | | | | | | |
| braking | 100 | 101 | 102 | 102 | 101 | 101 |
| performance | | | | | | |

TABLE 2

| | Com- | | | | | |
|---|---|---|---|---|---|---|
| | parative | | | | | |
| | Exam- | Exam- | Exam- | Exam- | Exam- | Exam- |
| | ple 2 | ple 6 | ple 7 | ple 8 | ple 9 | ple 10 |
| rubber hardness | 70 | 70 | 70 | 70 | 70 | 70 |
| of cap portion | | | | | | |
| (tread rubber) | | | | | | |
| rubber hardness | 60 | 60 | 60 | 60 | 60 | 69 |
| of conductive | | | | | | |
| portion | | | | | | |
| angle θ | 90 | 70 | 50 | 35 | 71 | 35 |
| [degree] of | | | | | | |
| branch portion | | | | | | |
| dry steering | 100 | 102 | 103 | 103 | 100 | 105 |
| stability | | | | | | |
| wet steering | 100 | 101 | 101 | 102 | 100 | 103 |
| stability | | | | | | |
| driving | 100 | 101 | 101 | 102 | 101 | 103 |
| performance | | | | | | |
| braking | 100 | 101 | 101 | 102 | 101 | 103 |
| performance | | | | | | |

In relation to the comparative example 1 in Table 1, improvement of each of the performances is recognized in all of the examples 1 to 3. In the same manner, the improvement of each of the performances is recognized in all of the examples 6 to 8, in relation to the comparative example 6 in Table 2. As a result, it is known that in the case that the tread rubber 30 and the conductive rubber 5 are the same in the rubber hardness, the smaller from 90 degrees to 35 degrees the angle of the branch portion 52 is, the more each of the performances (the steering stability on the dry road surface, the steering stability on the wet road surface, the braking performance and the driving performance) is improved.

With regard to the braking performance and the driving performance, it is thought that the improvement is caused by the improvement of the grounding performance of the tread rubber 30 existing between the adjacent branches on the basis of the low angle of the branch portions 52.

Further, with regard to the steering stability on the dry road surface and the wet road surface, since the deforming direction guide portion 5y is constructed, it is possible to receive the pressure in the vertical direction from the road surface while uniformly deforming to the outer side in the tire width direction, it is possible to appropriately receive the force along the tire width direction, and it is possible to generate the reaction force in a direction in which the branch portions 52 support a side force applied from the road surface at the cornering time. Further, since it is possible to inhibit the tread rubber 30 existing between the branch portions 52 from deforming so as to escape in the tire radial direction due to the side force, it is thought that the grounding performance is improved.

Further, according to the comparison between the example 4 and the example 1 in Table 1, it is known that the angle of the branch portions 52 is preferably equal to or less than 70 degrees since an extending margin is less in spite of the improvement of each of the performance in the example 4. Same applies to the example 9 and the example 6 in Table 2.

Further, according to the example 5 and the example 3 in Table 1, and the example 10 and the example 8 in Table 2, it is known that at least 1 degree in the hardness difference between the tread rubber 30 and the conductive portion 5 achieves the effect.

The description is given above of the embodiments according to the present invention with reference to the accompanying drawings, however, the specific structure should not be limited to these embodiments. The scope of the present invention is shown by claims as well as the description of the embodiments mentioned above, and includes all the changes within the equivalent meanings and scope of claims.

It is possible to apply the structure employed in each of the embodiments to the other optional embodiment. The particular structure of each of the portions is not limited to the embodiments mentioned above, but can be variously modified within a range which does not deviate from the scope of the present invention.

1. A pneumatic tire comprising:
a tread rubber which is arranged in a tread portion of the tire, forms a ground surface and is made of a conductive rubber; and
a conductive portion which is provided at least in one side of a tire width direction of the tread rubber, and is formed so as to connect the ground surface and a side surface or a bottom surface of a side end portion of the tread rubber in a tire meridian circle cross section through an inner portion of the tread rubber,
wherein the conductive portion is formed by a conductive rubber having a rubber hardness which is different from the tread rubber, and has a stem portion which heads for an inner side in the tire width direction from the side surface or the bottom surface of the side end portion of the tread rubber so as to terminate at an inner portion of the tread rubber, and a plurality of branch portions which are branched from a plurality of positions of the stem portion so as to head for an outer side in the tire width direction and be exposed to an outer surface of the tire, and
wherein the plurality of branch portions construct a tread rigidity changing portion which changes a rigidity of the tread portion in comparison with a case that the plurality of branch portions are not provided.

2. The pneumatic tire according to claim 1, wherein the plurality of branch portions are arranged so that an angle between a line connecting a branch position and an exposure position and a horizontal line heading for the outer side in the tire width direction is equal to or more than 0 degree and equal to or less than 70 degrees, in the tire meridian circle cross section, and the branch portion constructs a deforming direction guide portion guiding a direction in which the tread portion deforms due to a pressure from a road surface to the outer side in the tire width direction.

3. The pneumatic tire according to claim 1, wherein the branch portions are curved so as to protrude toward the outer side in the tire radial direction than a line connecting the branch position and the exposure position, in the tire meridian circle cross section.

4. The pneumatic tire according to claim 1, wherein at least two main grooves extending in a tire peripheral direction are formed in the tread rubber, and
wherein at least one branch portion and the stem portion are arranged at a position which laps over the main groove existing in the outermost side in the tire width direction as seen from the tire radial direction.
